(19) United States
(12) Patent Application Publication
(10) Pub. No.: US 2003/0139317 A1
(43) Pub. Date: Jul. 24, 2003

(54) Surfactant mixture with fatty alcohol alkoxylates made fron vegetable raw materials

(76) Inventors: Ansgar Behler, Bottrop (DE); Norbert Huebner, Langenfeld (DE); Alfred Westfechtel, Hilden (DE)

Correspondence Address: COGNIS CORPORATION, 2500 RENAISSANCE BLVD., SUITE 200, GULPH MILLS, PA, 19406

(21) Appl. No.: 10/203,112

(22) PCT Filed: Jan. 25, 2001
(86) PCT No.: PCT/EP01/00789

(30) Foreign Application Priority Data
Feb. 3, 2000 (DE) 10004677.0

(51) Int. Cl. C11D 17/00

(52) U.S. Cl. 510/421; 510/426; 510/425

(57) ABSTRACT

The invention relates to a surfactant mixture containing fatty alcohol alkoxylates. The inventive mixture can be obtained by alkoxylating vegetable-based fatty alcohols and anionic surfactants and, optionally, dispersing agents and other co-surfactants. The invention also relates to the use of the inventive surfactant mixtures in washing agents, rinsing agents and cleaning agents.

### FIELD OF THE INVENTION

This invention relates to a surfactant mixture containing fatty alcohol alkoxylates obtainable by alkoxylation of fatty alcohols of vegetable origin and anionic surfactants and optionally disintegrators and other co-surfactants and to the use of the surfactant mixtures according to the invention in laundry detergents, dishwashing detergents and cleaning compositions.

### PRIOR ART

Modern detergent formulations always contain mixtures of anionic and nonionic surfactants for optimally combating various soils. However, on account of the vigorous foaming associated with the use of anionic surfactants, corresponding defoaming agents have to be used. Unfortunately, this restricts the use of saturated, linear fatty alcohol ethoxylates, particularly at low washing temperatures of <40° C., because they tend migrate into the defoamer granules, completely or at least partly deactivating the defoamer in the process. The required foaming behavior of the preparation is thus no longer achieved.

EP 0 370 273 B1 (Henkel) describes the production of fatty alcohol mixtures with a particular specification from purely vegetable oils or fats, their ethoxylation and their use as a surfactant component.

The problem addressed by the present invention was to provide surfactant mixtures which would dissolve quickly and which would develop a very high washing and cleaning performance, even at 30° C. At the same time, deactivation of the defoamer would be avoided by the use of suitable surfactants. These properties are exhibited by surfactant mixtures which, besides conventional anionic surfactants, contain fatty alcohol alkoxylates based on vegetable, substantially unsaturated fatty alcohols.

It has also been found that, where the surfactant mixtures are used in laundry detergents, dishwashing detergents and cleaners, the quantity of defoaming agent can be greatly reduced. Without being tied to any particular theory, it has been observed that silicone-free paraffin-based defoamers above all can be used in far smaller quantities. This results in better environmental compatibility of the products. In addition, less expensive formulations can thus be produced. Formulations with, for example, a higher surfactant content and/or enzyme content which show improved washing and cleaning performance can also be produced in this way.

Surfactant mixtures containing conventional fatty alcohol ethoxylates can readily be replaced by the surfactant mixtures according to the invention in laundry detergents, dishwashing detergents and cleaning compositions. By using fatty alcohol alkoxylates corresponding to formula (I), anionic surfactants and optionally other co-surfactants, disintegrators and auxiliaries and additives, it is possible to produce surfactant mixtures which satisfy all the requirements modern laundry detergents, dishwashing detergents and cleaning compositions are expected to meet. The solubility of the granules is greatly improved by the process used to produce the surfactant mixtures. The surfactants and other ingredients can be released and activated particularly quickly.

### DESCRIPTION OF THE INVENTION

The present invention relates to surfactant mixtures containing

a. fatty alcohol alkoxylates corresponding to formula (I) based on vegetable unsaturated fatty alcohols with iodine values of 20 to 130 and a conjuene content of less than 4.5%:

R¹—O(CH₂R²CHO)ₓ—H (I)

in which

R¹ is an alkenyl group containing 6 to 22 carbon atoms.

R² is hydrogen or a methyl or ethyl group and

x has a value of 1 to 50, and

b. anionic surfactants.

Fatty Alcohol Alkoxylates Based on Vegetable Fatty Alcohols

The surfactant mixtures according to the invention contain fatty alcohol alkoxylates corresponding to formula (I) obtainable by pressure hydrolysis of vegetable fats and oils into fatty acids or by subsequent esterification or direct transesterification with methanol into the fatty acid methyl esters and subsequent selective hydrogenation to fatty alcohols with the double bonds intact and subsequent alkoxylation, preferably ethoxylation. Fatty alcohol ethoxylates are produced by ethoxylation of vegetable fatty alcohols R¹—OH as described in EP 370 273 B1.

The alkenyl group R¹ may be derived from primary unsaturated alcohols. Typical examples of unsaturated alcohols are undecen-1-ol, lauroleic alcohol, myristoleic alcohol, palmitoleic alcohol, petroselaidic alcohol, oleyl alcohol, elaidyl alcohol, ricinolyl alcohol, linoleyl alcohol, linolenyl alcohol, gadoleyl alcohol, arachidonic alcohol, erucic alcohol, brassidyl alcohol, palmitoleyl alcohol, petroselinyl alcohol, arachyl alcohol and mixtures thereof and mixtures of unsaturated and saturated fatty alcohols obtained by the process described in EP 0 724 555 B1.

The vegetable fatty alcohols are compounds of which a large part, i.e. at least 10% by weight, is unsaturated and which have iodine values of 20 to 130, preferably 20 to 110 and more particularly 20 to 85 and a conjuene content of less than 4.5% by weight and preferably below 6% by weight.

Fatty alcohol alkoxylates derived from monohydric unsaturated C₆₋₂₂ and more particularly C₆₋₁₈ alcohols with the formula R¹—OH are also preferred for the purposes of the invention.

The fatty alcohols are used in the form of their alkoxylates which are obtained by reaction with 1 to 50 mol, preferably 2 to 35 mol and more particularly 3 to 25 mol of 1,2-epoxyalkanes CH₂OCHR², where R² is hydrogen or a methyl or ethyl group. Fatty alcohol ethoxylates (R²=hydrogen) obtained by reaction with 1 to 50 mol, preferably 2 to 35 mol and more particularly 3 to 25 mol of ethylene oxide are preferably used. Fatty alcohol ethoxylates with a degree of ethoxylation of 50 to 60% by weight ethylene oxide are particularly preferred. The alkoxylation is carried out in the presence of catalysts, preferably alkaline catalysts, such as sodium methanolate, sodium hydroxide and potassium hydroxide.

In a preferred embodiment, the surfactant mixtures according to the invention contain 0.1 to 89% by weight, preferably 0.2 to 85% by weight and more particularly 0.5 to 70% by weight, based on the mixture, of fatty alcohol alkoxylates corresponding to formula (I), expressed as active substance.

The active substance content is calculated on the basis that all components are present as pure substances.

Anionic Surfactants

The sufactant mixture according to the invention contains anionic surfactants as a compulsory component. Typical examples of anionic surfactants are soaps, alkyl benzenesulfonates, secondary alkane sulfonates, olefin sulfonates, alkyl ether sulfonates, glycerol ether sulfonates, α-methyl ester sulfonates, sulfofatty acids, alkyl and/or alkenyl sulfates, alkyl ether sulfates, glycerol ether sulfates, hydroxy mixed ether sulfates, fatty alcohol (ether) phosphates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside sulfates, protein fatty acid condensates (particularly wheat-based vegetable products) and alkyl (ether) phosphates. If the anionic surfactants contain polyglycol ether chains, the polyglycol ether chains may have a conventional homolog distribution, although they preferably have a narrow homolog distribution.

Alkyl and/or alkenyl sulfates, alkyl ether sulfates, alkyl benzenesulfonates, soaps, monoglyceride (ether) sulfates and alkanesulfonates, more particularly fatty alcohol sulfates, fatty alcohol ether sulfates, secondary alkanesulfonates and linear alkyl benzenesulfonates are preferably used as anionic surfactants.

Alkyl and/or Alkenyl Sulfates

Alkyl and/or alkenyl sulfates, which are often also referred to as fatty alcohol sulfates, are understood to be the sulfation products of primary alcohols which correspond to formula (II):

R³O—SO₃X (II)

in which R³ is a linear or branched, aliphatic alkyl and/or alkenyl group containing 6 to 22 carbon atoms and preferably 12 to 18 carbon atoms and X is an alkali metal and/or alkaline earth metal, ammonium, alkyl ammoium, alkanolammonium or glucammonium. Typical examples of alkyl sulfates which may be used in accordance with the invention are the sulfation products of caproic alcohol, caprylic alcohol, capric alcohol, 2-ethyl hexyl alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol and erucyl alcohol and the technical mixtures thereof obtained by high-pressure hydrogenation of technical methyl ester fractions or aldehydes from Roelen's oxo synthesis. The sulfation products may advantageously be used in the form of their alkali metal salts and particularly their sodium salts. Alkyl sulfates based on C_{16/18} tallow fatty alcohols or vegetable fatty alcohols of comparable C chain distribution in the form of their sodium salts are particularly preferred.

Alkyl Ether Sulfates

Alkyl ether sulfates (“ether sulfates”) are known anionic surfactants which, on an industrial scale, are produced by SO₃ or chlorosulfonic acid (CSA) sulfation of fatty alcohol or oxoalcohol polyglycol ethers and subsequent neutralization. Ether sulfates suitable for use in accordance with the invention correspond to formula (III):

R⁴O—(CH₂CH₂O)ₐSO₃X (III)

in which R⁴ is a linear or branched alkyl and/or alkenyl radical containing 6 to 22 carbon atoms, a is a number of 1 to 10 and X is an alkali metal and/or alkaline earth metal, ammonium, alkylammonium, alkanolammonium or glucammonium. Typical examples are the sulfates of addition products of on average 1 to 10 and more particularly 2 to 5 mol of ethylene oxide onto caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and technical mixtures thereof in the form of their sodium and/or magnesium salts. The ether sulfates may have both a conventional homolog distribution and a narrow homolog distribution. It is particularly preferred to use ether sulfates based on adducts of on average 2 to 3 mol ethylene oxide with technical C_{12/14} or C_{12/18} coconut fatty alcohol fractions in the form of their sodium and/or magnesium salts.

Alkyl Benzenesulfonates

Alkyl benzenesulfonates preferably correspond to formula (IV):

R⁵—Ph—SO₃X (IV)

in which R⁵ is a branched, but preferably linear alkyl group containing 10 to 18 carbon atoms, Ph is a phenyl group and X is an alkali metal and/or alkaline earth metal, ammonium, alkyl ammonium, alkanolammonium or glucammonium. Dodecyl benzenesulfonates, tetradecyl benzenesulfonates, hexadecyl benzenesulfonates and technical mixtures thereof in the form of the sodium salts are preferably used.

Soaps

Finally, soaps are understood to be fatty acid salts corresponding to formula (V):

R⁶CO—OX (V)

in which R⁶CO is a linear or branched, saturated or unsaturated acyl group containing 6 to 22 and preferably 12 to 18 carbon atoms and X is alkali and/or alkaline earth metal, ammonium, alkylammonium or alkanolammonium. Typical examples are the sodium, potassium, magnesium, ammonium and triethanolammonium salts of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. Coconut oil fatty acid or palm kernel oil fatty acid in the form of their sodium or potassium salts are preferably used.

Monoglyceride (Ether)Sulfates

Monoglyceride sulfates and monoglyceride ether sulfates are known anionic surfactants which may be obtained by the relevant methods of preparative organic chemistry. They are normally produced from triglycerides by transesterification to the monoglycerides, optionally after ethoxylation, followed by sulfation and neutralization. The partial glycerides may also be reacted with suitable sulfating agents, preferably gaseous sulfur trioxide or chlorosulfonic acid [cf. EP-B1 0 561 825, EP-B1 0 561 999 (Henkel)]. If desired, the neutralized products may be subjected to ultrafiltration to reduce the electrolyte content to a desired level [DE-A1 42 04 700 (Henkel)]. Overviews of the chemistry of monoglyceride sulfates have been published, for example, by A. K. Biswas et al. in J. Am. Oil. Chem. Soc. 37, 171 (1960) and by F. U. Ahmed in J. Am. Oil. Chem. Soc. 67, 8 (1990). The monoglyceride (ether)sulfates suitable for the purposes of the invention correspond to formula (VI):

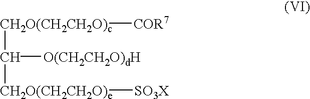

in which R⁷CO is a linear or branched acyl group containing 6 to 22 carbon atoms, c, d and e together stand for 0 or numbers of 1 to 30 and preferably 2 to 10 and X is an alkali metal or alkaline earth metal. Typical examples of monoglyceride (ether)sulfates suitable for the purposes of the invention are the reaction products of lauric acid monoglyceride, coconut fatty acid monoglyceride, palmitic acid monoglyceride, stearic acid monoglyceride, oleic acid monoglyceride and tallow fatty acid monoglyceride and ethylene oxide adducts thereof with sulfur trioxide or chlorosulfonic acid in the form of their sodium salts. Monoglyceride sulfates corresponding to formula (VI), in which R⁷CO is a linear acyl group containing 8 to 18 carbon atoms, are preferably used.

Alkanesulfonates

Alkane sulfonates may be divided into primary and secondary alkanesulfonates. These are understood to be compounds corresponding to formula (VII):

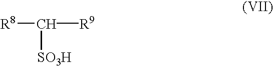

where—in the case of primary alkanesulfonates—R⁸ is hydrogen and R⁹ is an alkyl group containing no more than 50 carbon atoms. Secondary alkanesulfonates are preferred. R⁸ and R⁹ stand for alkyl groups and, together, should contain no more than 50 carbon atoms.

The surfactant mixtures may contain 0.1 to 89% by weight, preferably 0.2 to 85% by weight and more particularly 0.5 to 70% by weight, based on the mixture, of anionic surfactants, expressed as active substance.

In a preferred embodiment, the surfactant mixtures according to the invention contain fatty alcohol alkoxylates corresponding to formula (I) and anionic surfactants in a ratio by weight of 1:90 to 90:1, preferably 1:50 to 50:1 and more particularly 1:10 to 10:1.

The surfactant mixtures according to the invention preferably contain fatty alcohol alkoxylates of formula (I) and anionic surfactants, expressed as active substance, in quantities of 0.1 to 89% by weight, preferably 0.2 to 85% by weight and more particularly 0.5 to 70% by weight, based on the mixture. The active substance is calculated on the basis that all components are present as pure substances.

Co-Surfactants

In another embodiment, the surfactant mixtures according to the invention contain co-surfactants and/or disintegrators. Other nonionic surfactants, cationic surfactants and/or amphoteric surfactants may be present as co-surfactants.

Nonionic Surfactants

The surfactant granules according to the invention may contain other nonionic surfactants. Typical examples of other nonionic surfactants are alkoxylates of alkanols, end-capped alkoxylates of alkanols with no free OH groups, alkoxylated fatty acid lower alkyl esters, hydroxy mixed ethers, alkylphenol polyglycol ethers, fatty acid polyglycol esters, fatty acid amide polyglycol ethers, fatty amine polyglycol ethers, alkoxylated triglycerides, mixed ethers and mixed formals, alk(en)yl oligoglycosides, fatty acid-N-alkyl glucamides, protein hydrolyzates (more particularly wheat-based vegetable products), polyol fatty acid esters, sugar esters, sorbitan esters, polysorbates and amine oxides. If the nonionic surfactants contain polyglycol ether chains, they may have a conventional homolog distribution although they preferably have a narrow homolog distribution.

The other nonionic surfactants are preferably selected from the group consisting of alkyl and/or alkenyl oligoglycosides, hydroxy mixed ethers, alkoxylates of alkanols, more particularly fatty alcohol polyethylene glycol/polypropylene glycol ethers (FAEO/PO) or fatty alcohol polypropylene glycol/polyethylene glycol ethers (FAPO/EO), end-capped alkoxylates of alkanols, more particularly end-capped fatty alcohol polyethylene glycol/polypropylene glycol ethers or end-capped fatty alcohol polypropylene glycol/polyethylene glycol ethers, and fatty acid lower alkyl esters and amine oxides.

Alkyl and/or Alkenyl Oligoglycosides

Alkyl and/or alkenyl oligoglycosides corresponding to formula (VIII):

R¹⁰O-[G]ₚ (VIII)

are preferably used. In formula (VIII), R¹⁰ is an alkyl and/or alkenyl group containing 4 to 22 carbon atoms, G is a sugar unit containing 5 or 6 carbon atoms and p is a number of 1 to 10. They may be obtained by the relevant methods of preparative organic chemistry. EP 0 301 298 A1 and WO 90/03977 are cited as representative of the extensive literature available on the subject. The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index p in general formula (VIII) indicates the degree of oligomerization (DP), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides having a degree of oligomerization of less than 1.7 and, more particularly, between 1.2 and 1.4 are preferred from the applicational point of view. The alkyl or alkenyl radical R¹⁰ may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty acid methyl esters or in the hydrogenation of aldehydes from Roelen's oxosynthesis. Alkyl oligoglucosides having a chain length of C₈ to C₁₀ (DP=1 to 3), which are obtained as first runnings in the separation of technical C₈₋₁₈ coconut oil fatty alcohol by distillation and which may contain less than 6% by weight of C₁₂ alcohol as an impurity, and also alkyl oligoglucosides based on technical C_{9/11} oxoalcohols (DP=1 to 3) are preferred. In addition, the alkyl or alkenyl radical R¹⁰ may also be derived from primary alcohols containing 12 to 22 and preferably 12 to 14 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} cocoalcohol with a DP of 1 to 3 are preferred.

Hydroxy Mixed Ethers

Hydroxy mixed ethers corresponding to formula (IX):

R¹¹O[CH₂CHR¹²O]_{b}[CH₂CHR¹³O]_{y}CR¹⁴HCH(OH)R¹⁵ (IX)

In formula (IX), R¹¹ is an alkyl and/or alkenyl group containing 4 to 22 carbon atoms, R¹² is hydrogen or a methyl or ethyl group, R¹³ is hydrogen or a methyl or ethyl group, R¹⁴ is hydrogen or an alkyl group containing 2 to 18 carbon atoms, R¹⁵ is an alkyl group containing 2 to 22 carbon atoms, b=0 or 1 to 30, y=0 or 1 to 30, x+y>=1.

Hydroxy mixed ethers are known from the literature and are described, for example, in German patent application DE 19738866. Hydroxy mixed ethers may be ring opening products of both internal olefins (R¹⁴≠hydrogen) or terminal olefins (R¹⁴=hydrogen), the latter being preferred. They are prepared by reaction of 1,2-epoxyalkanes (R¹⁵CHOCR¹⁴H), where R¹⁴ is hydrogen, R¹⁵ is an aliphatic saturated, linear or branched alkyl group containing 2 to 22 and more particularly 6 to 16 carbon atoms, with alkoxylated alcohols.

Hydroxy mixed ethers preferred for the purposes of the invention are those derived from alkoxylates of monohydric alcohols with the formula R¹¹—OH containing 4 to 18 carbon atoms, R¹¹ being an aliphatic, saturated, linear or branched alkyl group, more particularly containing 6 to 16 carbon atoms. Examples of suitable straight-chain alcohols are butan-1-ol, caproic alcohol, oenanthic alcohol, caprylic alcohol, pelargonic alcohol, capric alcohol, undecan-1-ol, lauryl alcohol, tridecan-1-ol, myristyl alcohol, pentadecan-1-ol, palmityl alcohol, heptadecan-1-ol, stearyl alcohol, nonadecan-1-ol, arachidyl alcohol, heneicosan-1-ol, behenyl alcohol and the technical mixtures thereof obtained in the high-pressure hydrogenation of technical methyl esters based on fats and oils. Examples of branched alcohols are so-called oxo alcohols which generally contain 2 to 4 methyl groups as branches and are produced by the oxo process and so-called Guerbet alcohols which are branched in the 2-position by an alkyl group. Suitable Guerbet alcohols are 2-ethyl hexanol, 2-butyl octanol, 2-hexyl decanol and/or 2-octyl dodecanol.

The alcohols are used in the form of their alkoxylates which are prepared in known manner by reaction of the alcohols in any order with ethylene oxide, propylene oxide and/or butylene oxide. Alkoxylates of alcohols formed by reaction with 10 to 50 mol ethylene oxide (R¹², R¹³ and R¹⁴=hydrogen and b+y=1-50) are preferably used. Both alkoxylates obtained by reaction of alcohol with 1 to 10 mol propylene oxide (R¹²=methyl, b=1-10) and 10 to 30 mol ethylene oxide (R¹³=hydrogen, y=10-30) and those obtained by reaction of alcohol with 10 to 30 mol ethylene oxide (R¹²=hydrogen, b=10-30) and 1 to 10 mol propylene oxide (R¹³=methyl, y=1-10)—R¹⁴ being hydrogen in either case—are preferred.

Particularly suitable hydroxy mixed ethers are those corresponding to formula (IX), where R¹⁴ is hydrogen, R¹² is a methyl group and R¹³ is hydrogen, which have advantageously been produced by reaction of alcohol with 1 to 3 mol propylene oxide (b=1-3) and then with 10 to 25 mol ethylene oxide (y=10-25).

Fatty Alcohol Polyethylene Glycol/Polypropylene Glycol Ethers

A preferred embodiment is characterized by the use of optionally end-capped fatty alcohol polyethylene glycol/polypropylene glycol ethers corresponding to formula (X):

R¹⁶O(CH₂CH₂O)ₙ[CH₂(CH₃)CHO]ₘR¹⁷ (X)

in which R¹⁶ is an alkyl and/or alkenyl group containing 8 to 22 carbon atoms, R¹⁷ is H or an alkyl group containing 1 to 8 carbon atoms, n is a number of 1 to 40, preferably 1 to 30 and more particularly 1 to 15 and m is 0 or a number of 1 to 10.

Fatty Alcohol Polypropylene Glycol/Polyethylene Glycol Ethers

Optionally end-capped fatty alcohol polypropylene glycol/polyethylene glycol ethers corresponding to formula (XI):

R¹⁸O[CH₂(CH₃)CHO]_{q}(CH₂CH₂O)ᵣR¹⁹ (XI)

in which R¹⁸ is an alkyl and/or alkenyl group containing 8 to 22 carbon atoms, R¹⁹ is H or an alkyl group containing 1 to 8 carbon atoms, q is a number of 1 to 5 and r is a number of 0 to 15, are also suitable,

In a preferred embodiment, the mixtures according to the invention contain fatty alcohol polyethylene glycol/polypropylene glycol ethers corresponding to formula (X) in which R¹⁶ is an aliphatic saturated, linear or branched alkyl group containing 8 to 16 carbon atoms, n is a number of 1 to 10, m is 0 and R¹⁷ is hydrogen. These compounds (X) are products of the addition of 1 to 10 mol ethylene oxide onto monohydric alcohols. Suitable alcohols are the above-described alcohols, such as fatty alcohols, oxo alcohols and Guerbet alcohols. Other suitable alcohol ethoxylates are those which have a narrow homolog distribution.

Other suitable representatives of non-end-capped representatives are those corresponding to formula (X) in which R¹⁶ is an aliphatic, saturated, linear or branched alkyl group containing 8 to 16 carbon atoms, n is a number of 2 to 7, m is a number of 3 to 7 and R¹⁷ is hydrogen. These compounds (X) are products of the addition of monohydric alcohols of the type already described alkoxylated first with 2 to 7 mol ethylene oxide and then with 3 to 7 mol propylene oxide.

The end-capped compounds of formula (X) are terminated by a C₁₋₈ alkyl group (R¹⁷). In the literature, such compounds are also commonly referred to as mixed ethers. Suitable representatives are methyl-group-terminated compounds of formula (X) in which R¹⁶ is an aliphatic, saturated, linear or branched alkyl group containing 8 to 16 carbon atoms, n is a number of 2 to 7, m is a number of 3 to 7 and R⁷ is a methyl group. Compounds such as these may readily be prepared by reacting the corresponding non-end-capped fatty alcohol polyethylene glycol/polypropylene glycol ethers with methyl chloride in the presence of a base.

Other suitable representatives of alkyl-group-terminated compounds are those of formula (X), in which R¹⁶ is an aliphatic, saturated, linear or branched alkyl group containing 8 to 16 carbon atoms, n is a number of 5 to 15, m is 0 and R¹⁷ is an alkyl group containing 4 to 8 carbon atoms. The end capping is preferably carried out with a linear or branched butyl group by reacting the corresponding fatty alcohol polyethylene glycol ether with n-butyl chloride or with tert.butyl chloride in the presence of bases.

Optionally end-capped fatty alcohol polypropylene glycol/polyethylene glycol ethers of formula (XI) may be present instead of or in admixture with the compounds of formula (X). Compounds such as these are described, for example, in DE-A1-43 23 252. Particularly preferred representatives of the compounds of formula (XI) are those in which R¹⁸ is an aliphatic, saturated, linear or branched alkyl group containing 8 to 16 carbon atoms, q is a number of 1 to 5, r is a number of 1 to 6 and R¹⁹ is hydrogen. Compounds such as these are preferably products of the addition of 1 to 5 mol propylene oxide and 1 to 6 mol ethylene oxide onto monohydric alcohols which have already been described as suitable in connection with the hydroxy mixed ethers.

Alkoxylated Fatty Acid Lower Alkyl Esters

Suitable alkoxylated fatty acid lower alkyl esters are surfactants corresponding to formula (XII):

R²⁰CO—(OCH₂CHR²¹)_{w}OR²² (XII)

in which R²⁰CO is a linear or branched, saturated and/or unsaturated acyl group containing 6 to 22 carbon atoms, R²¹ is hydrogen or methyl, R²² represents linear or branched alkyl groups containing 1 to 4 carbon atoms and w is a number of 1 to 20. Typical examples are the formal insertion products of on average 1 to 20 and preferably 5 to 10 mol ethylene and/or propylene oxide into the methyl, ethyl, propyl, isopropyl, butyl and tert.butyl esters of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic cid, petroselic acid, linoleic acid, linolenic acid, elaeostearic acid, arachic acid, gadoleic acid, behenic acid and erucic acid and technical mixtures thereof. Normally, the products are obtained by insertion of the alkoxides into the carbonyl ester bond in the presence of special catalysts such as, for example, calcined hydrotalcite. Reaction products of on average 5 to 10 mol ethylene oxide into the ester bond of technical coconut fatty acid methyl esters are particularly preferred.

Amine Oxides

Compounds Corresponding to Formula (XIII) and/or (XIV):

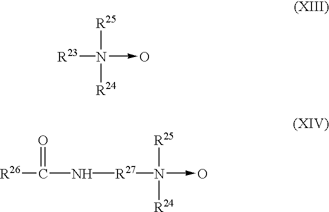

may be used as amine oxides. The amine oxides corresponding to formula (XIII) are produced by oxidation of tertiary fatty amines having an least one long alkyl chain in the presence of hydrogen peroxide. In the amine oxides of formula (XIII) suitable for the purposes of the invention, R²³ is a linear or branched alkyl chain containing 6 to 22 and preferably 12 to 18 carbon atoms and R²⁴ and R²⁵ independently of one another have the same meaning as R²³ or represent an optionally hydroxysubstituted alkyl group containing 1 to 4 carbon atoms. Preferred amine oxides of formula (XIII) are those in which R²³ and R²⁴ represent C_{12/14} or C_{12/18} coconut alkyl groups and R²⁵ is a methyl or hydroxyethyl group. Other preferred amine oxides of formula (XIII) are those in which R²³ is a C_{12/14} or C_{12/18} coconut alkyl group and R²⁴ and R²⁵ represent a methyl or hydroxyethyl group. Other suitable amine oxides are alkylamidoamine oxides corresponding to formula (XIV) where the alkylamido group R²⁶CONH is formed by the reaction of linear or branched carboxylic acids preferably containing 6 to 22 and more particularly 12 to 18 carbon atoms, more particularly from C_{12/14} or C_{12/18} fatty acids, with amines. R²⁷ is a linear or branched alkenyl group containing 2 to 6 and preferably 2 to 4 carbon atoms and R²⁴ and R²⁵ are as defined for formula (VI).

In another preferred embodiment, the surfactant mixtures according to the invention may contain 0.1 to 89% by weight, preferably 0.2 to 85% by weight and more particularly 0.5 to 70% by weight, based on the mixture, of other nonionic surfactants expressed as active substance.

In one preferred embodiment, the surfactant mixtures according to the invention contain co-surfactants selected from the group of cationic and/or amphoteric surfactants formed by esterquats, alkyl betaines, alkyl amidobetaines, imidazolinium betaines.

Cationic Surfactants

Typical examples of cationic surfactants are, in particular, tetraalkylammonium compounds such as, for example, dimethyl distearyl ammonium chloride or Hydroxyethyl Hydroxycetyl Dimmonium Chloride (Dehyquart E) and esterquats.

Esterquats

Esterquats are, for example, quaternized fatty acid triethanolamine ester salts corresponding to formula (XIVa):

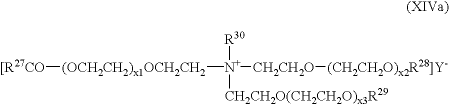

in which R²⁷CO is an acyl group containing 6 to 22 carbon atoms, R²⁸ and R²⁹ independently of one another represent hydrogen or have the same meaning as R²⁷CO, R³⁰ is an alkyl group containing 1 to 4 carbon atoms or a (CH₂CH₂O)ₓ₄H group, x1, x2 and x3 together stand for 0 or numbers of 1 to 12, x4 is a number of 1 to 12 and Y is halide, alkyl sulfate or alkyl phosphate. Typical examples of esterquats which may be used in accordance with the invention are products based on caproic acid, caprylic acid, capric acid, lauric acid, myristic acid, palmitic acid, isostearic acid, stearic acid, oleic acid, elaidic acid, arachic acid, behenic acid and erucic acid and the technical mixtures thereof obtained for example in the pressure hydrolysis of natural fats and oils. Technical C_{12/18} coconut fatty acids and, in particular, partly hydrogenated C_{16/18} tallow or palm oil fatty acids and high-elaidic C_{16/18} fatty acid cuts are preferably used. To produce the quaternized esters, the fatty acids and the triethanolamine may be used in a molar ratio of 1.1:1 to 3:1. With the performance properties of the esterquats in mind, a ratio of 1.2:1 to 2.2:1 and preferably 1.5:1 to 1.9:1 has proved to be particularly advantageous. The preferred esterquats are technical mixtures of mono-, di- and triesters with an average degree of esterification of 1.5 to 1.9 and are derived from technical C_{16/18} tallow or palm oil fatty acid (iodine value 0 to 40). In performance terms, quaternized fatty acid triethanolamine ester salts corresponding to formula (XIVa), in which R²⁷CO is an acyl group containing 16 to 18 carbon atoms, R²⁸ has the same meaning as R²⁷CO, R²⁹ is hydrogen, R³⁰ is a methyl group, (x1+x2+x3) stands for 0 and Y stands for methyl sulfate, have proved to be particularly advantageous.

Other suitable esterquats besides the quaternized fatty acid triethanolamine ester salts are quaternized ester salts of fatty acids with diethanolalkyamines corresponding to formula (XV):

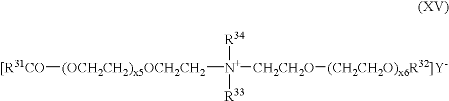

in which R³¹CO is an acyl group containing 6 to 22 carbon atoms, R³² is hydrogen or has the same meaning as R³¹CO, R³³ and R³⁴ independently of one another are alkyl groups containing 1 to 4 carbon atoms, x5 and x6 together stand for 0 or numbers of 1 to 12 and Y stands for halide, alkyl sulfate or alkyl phosphate.

Finally, another group of suitable esterquats are the quaternized ester salts of fatty acids with 1,2-dihydroxypropyl dialkylamines corresponding to formula (XVI):

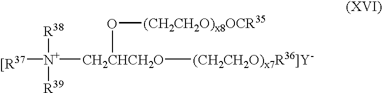

in which R³⁵CO is an acyl group containing 6 to 22 carbon atoms, R³⁶ is hydrogen or has the same meaning as R³⁵CO, R³⁷, R³⁸ and R³⁹ independently of one another are alkyl groups containing 1 to 4 carbon atoms, x7 and x8 together stand for 0 or numbers of 1 to 12 and Y stands for halide, alkyl sulfate or alkyl phosphate.

Finally, other suitable esterquats are substances in which the ester bond is replaced by an amide bond and which—preferably based on diethylenetriamine—correspond to formula (XVII):

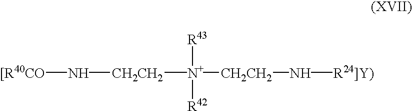

in which R⁴⁰CO is an acyl group containing 6 to 22 carbon atoms, R⁴¹ is hydrogen or has the same meaning as R⁴⁰CO, R⁴² and R⁴³ independently of one another are alkyl groups containing 1 to 4 carbon atoms and Y is halide, alkyl sulfate or alkyl phosphate. Amide esterquats such as these are commercially obtainable, for example, under the name of Incroquat® (Croda).

Amphoteric Surfactants

The preparations may contain alkyl betaines, alkyl amidobetaines, aminopropionates, aminoglycinates, imidazolinium betaines and/or sulfobetaines as amphoteric or zwitterionic surfactants.

Alkyl Betaines

Examples of suitable alkyl betaines are the carboxyalkylation products of secondary and, in particular, tertiary amines corresponding to formula (XVIII):

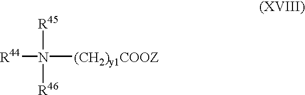

in which R⁴⁴ represents alkyl and/or alkenyl groups containing 6 to 22 carbon atoms, R⁴⁵ represents hydrogen or alkyl groups containing 1 to 4 carbon atoms, R⁴⁶ represents alkyl groups containing 1 to 4 carbon atoms, y1 is a number of 1 to 6 and Z is an alkali metal and/or alkaline earth metal or ammonium. Typical examples are the carboxymethylation products of hexylmethyl amine, hexyldimethyl amine, octyldimethyl amine, decyldimethyl amine, dodecylmethyl amine, dodecyldimethyl amine, dodecylethylmethyl amine, C_{12/14} cocoalkyldimethyl amine, myristyldimethyl amine, cetyldimethyl amine, stearyldimethyl amine, stearylethylmethyl amine, oleyldimethyl amine, C_{16/18} tallow alkyldimethyl amine and technical mixtures thereof.

Alkyl Amidobetaine

Also suitable are carboxyalkylation products of amidoamines corresponding to formula (XIX):

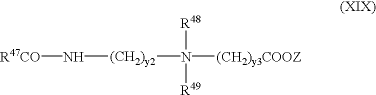

in which R⁴⁷CO is an aliphatic acyl group containing 6 to 22 carbon atoms and 0 or 1 to 3 double bonds, R⁴⁸ is hydrogen or represents alkyl groups containing 1 to 4 carbon atoms, R⁴⁹ represents alkyl groups containing 1 to 4 carbon atoms, y2 and y3 independently of one another are numbers of 1 to 6 and Z is an alkali metal and/or alkaline earth metal or ammonium. Typical examples are reaction products of fatty acids containing 6 to 22 carbon atoms, namely caproic acid, caprylic acid, capric acid, lauric acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof, with N,N-dimethylaminoethyl amine, N,N-dimethylaminopropyl amine, N,N-diethylaminoethyl amine and N,N-diethylaminopropyl amine which are condensed with sodium chloroacetate. A condensation product of C_{8/18}-cocofatty acid-N,N-dimethylaminopropyl amide with sodium chloroacetate is preferably used.

Imidazolinium Betaines

Imidazolinium betaines may also be used. These compounds are also known compounds which may be obtained, for example, by cyclizing condensation of 1 or 2 mol of fatty acid with polyfunctional amines such as, for example, aminoethyl ethanolamine, (AEEA) or diethylenetriamine. The corresponding carboxyalkylation products are mixtures of different open-chain betaines. Typical examples are condensation products of the fatty acids mentioned above with AEEA, preferably imidazolines based on lauric acid or—again—C_{12/14} cocofatty acid which are subsequently betainized with sodium chloroacetate.

Normally, the surfactant mixtures according to the invention may contain cationic and/or amphoteric surfactants in quantities of 1 to 50, preferably 5 to 35 and more particularly 15 to 25% by weight.

Disintegrators

The surfactant granules according to the invention may contain disintegrating agents (disintegrators). Disintegrators are substances which are present in the surfactant granules to accelerate their disintegration on contact with water. Disintegrators are reviewed, for example, in J. Pharm. Sci. 61 (1972) and in Römpp Chemielexikon, 9th Edition, Vol. 6, page 4440. Viewed macroscopically, the disintegrators may be homogeneously distributed in the granules although, when observed under a microscope, they form zones of increased concentration due to their production. Preferred disintegrators include polysaccharides, for example natural starch and derivatives thereof (carboxymethyl starch, starch glycolates in the form of their alkali metal salts, agar agar, guar gum, pectins, etc.), celluloses and derivatives thereof (carboxymethyl cellulose, microcrystalline cellulose), polyvinyl pyrrolidone, collodion, alginic acid and alkali metal salts thereof (alginates), amorphous or even partly crystalline layer silicates (bentonites), polyurethanes, polyethylene glycols and effervescent systems. Other disintegrators which may be present in accordance with the invention can be found, for example, in WO 98/40462 (Rettenmaier), WO 98/55583 and WO 98/55590 (Unilever) and WO 98/40463, DE 19709991 and DE 19710254 (Henkel). Reference is specifically made to the teaching of these documents.

The surfactant mixtures according to the invention preferably contain surfactants and disintegrators—based on their solids contents (pure substance content)—in a ratio by weight of 1:10 to 10:1, preferably 1:5 to 5:1 and more particularly 1:2 to 2:1.

In a preferred embodiment, the surfactant mixtures according to the invention are present as granules which are optionally compacted before, during or after the granulation process. Compacting enhances the dissolving and disintegrating properties of the granules. In addition, it is advisable to adjust the water content of the disintegrators or the surfactant granules to such a value that they do not automatically begin to swell during storage. The residual water content should preferably be below 10% by weight.

Laundry Detergents, Dishwashing Detergents and Cleaners

The present invention also relates to laundry detergents, dishwashing detergents and cleaners containing the surfactant mixtures according to the invention. The detergents/cleaners may be present in the form of powders, granules, extrudates, agglomerates and, more particularly, tablets and may contain other typical ingredients which are described hereinafter under the heading “auxiliaries and additives”.

Auxiliaries and Additives

Besides the ingredients mentioned, the laundry detergents, dishwashing detergents and cleaners may contain other known additives, above all builders, optical brighteners, enzymes, enzyme stabilizers, defoamers, co-disintegrators, proteins and protein derivatives, small quantities of neutral filler salts and dyes and perfumes and the like.

Zeolites, for example, may be used as builders. The finely crystalline, synthetic zeolite containing bound water often used as a detergent builder is preferably zeolite A and/or zeolite P. Zeolite MAP® (Crosfield) is a particularly preferred P-type zeolite. However, zeolite X and mixtures of A, X and/or P and also Y are also suitable. A co-crystallized sodium/potassium aluminium silicate of zeolite A and zeolite X commercially available as VEGOBOND AX® (from Condea Augusta S.p.A.) is also of particular interest. The zeolite may be used in the form of a spray-dried powder or even in the form of an undried stabilized suspension still moist from its production. Where the zeolite is used in the form of a suspension, the suspension may contain small additions of nonionic surfactants as stabilizers, for example 1 to 3% by weight, based on zeolite, of ethoxylated C₁₂₋₁₈ fatty alcohols containing 2 to 5 ethylene oxide groups, C₁₂₋₁₄ fatty alcohols containing 4 to 5 ethylene oxide groups or ethoxylated isotridecanols. Suitable zeolites have a mean particle size of less than 10 μm (volume distribution, as measured by the Coulter Counter method) and contain preferably 18 to 22% by weight and more preferably 20 to 22% by weight of bound water.

Suitable substitutes or partial substitutes for phosphates and zeolites are crystalline layer sodium silicates corresponding to the general formula NaMSiₓO₂ₓ₊₁AyH₂O, where M is sodium or hydrogen, x is a number of 1.9 to 4 and y is a number of 0 to 20, preferred values for x being 2, 3 or 4. Crystalline layer silicates such as these are described, for example, in European patent application EP 0 164 514 A1. Preferred crystalline layer silicates corresponding to the above formula are those in which M is sodium and x assumes the value 2 or 3. Both β- and δ-sodium disilicates Na₂Si₂O₅AyH₂O are particularly preferred, β-sodium disilicate being obtainable, for example, by the process described in International patent application WO 91/08171. Other suitable layer silicates are known, for example, from patent applications DE 2334899 A1, EP 0026529 A1 and DE 3526405 A1. The suitability of these layer silicates is not limited to a particular composition or structural formula. However, smectites, more especially bentonites, are preferred for the purposes of the present invention. Suitable layer silicates which belong to the group of water-swellable smectites are, for example, those corresponding to the following general formulae:

| | |
|---|---|
| (OH)₄Si_{8-y}Al_{y}(MgₓAl₄₋ₓ)O₂₀ | montmorillonite |
| (OH)₄Si_{8-y}Al_{y}(Mg_{6-z}Li_{z})O₂₀ | hectorite |
| (OH)₄Si_{8-y}Al_{y}(Mg_{6-z}Al_{z})O₂₀ | saponite |

where x=0 to 4, y=0 to 2 and z=0 to 6. Small amounts of iron may additionally be incorporated in the crystal lattice of the layer silicates corresponding to the above formulae. In addition, by virtue of their ion-exchanging properties, the layer silicates may contain hydrogen, alkali metal and alkaline-earth metal ions, more particularly Na⁺ and Ca²⁺. The quantity of water of hydration is generally in the range from 8 to 20% by weight and is dependent upon the degree of swelling or upon the treatment method. Suitable layer silicates are known, for example, from U.S. Pat. Nos. 3,966,629 4,062,647, EP 0026529 A1 and EP 0028432 A1. Layer silicates which, by virtue of an alkali treatment, are largely free from calcium ions and strongly coloring iron ions are preferably used.

Other preferred builders are amorphous sodium silicates with a modulus (Na₂O:SiO₂ ratio) of 1:2 to 1:3.3, preferably 1:2 to 1:2.8 and more preferably 1:2 to 1:2.6 which dissolve with delay and exhibit multiple wash cycle properties. The delay in dissolution in relation to conventional amorphous sodium silicates can have been obtained in various ways, for example by surface treatment, compounding, compacting or by overdrying. In the context of the invention, the term “amorphous” is also understood to encompass “X-ray amorphous”. In other words, the silicates do not produce any of the sharp X-ray reflexes typical of crystalline substances in X-ray diffraction experiments, but at best one or more maxima of the scattered X-radiation which have a width of several degrees of the diffraction angle. Particularly good builder properties may even be achieved where the silicate particles produce crooked or even sharp diffraction maxima in electron diffraction experiments. This may be interpreted to mean that the products have microcrystalline regions between 10 and a few hundred nm in size, values of up to at most 50 nm and, more particularly, up to at most 20 nm being preferred. So-called X-ray amorphous silicates such as these, which also dissolve with delay in relation to conventional waterglasses, are described for example in German patent application DE-A-4400024 A1. Compacted amorphous silicates, compounded amorphous silicates and overdried X-ray-amorphous silicates are particularly preferred.

The generally known phosphates may of course also be used as builders providing their use should not be avoided on ecological grounds. The sodium salts of the orthophosphates, the pyrophosphates and, in particular, the tripolyphosphates are particularly suitable. Their content is generally no more than 25% by weight and preferably no more than 20% by weight, based on the final composition. In some cases, it has been found that, in combination with other builders, tripolyphosphates in particular produce a synergistic improvement in multiple wash cycle performance, even in small quantities of up to at most 10% by weight, based on the final composition.

The builders are present in the laundry/dishwashing detergents and cleaners in quantities of 0 to 70% by weight, preferably in quantities of 10 to 60% by weight and more particularly in quantities of 20 to 40% by weight, based on the detergent/cleaner.

Useful organic builders are, for example, the polycarboxylic acids usable in the form of their sodium salts, such as citric acid, adipic acid, succinic acid, glutaric acid, tartaric acid, sugar acids, aminocarboxylic acids, nitrilotriacetic acid (NTA), providing its use is not ecologically unsafe, and mixtures thereof. Preferred salts are the salts of the polycarboxylic acids, such as citric acid, adipic acid, succinic acid, glutaric acid, tartaric acid, sugar acids and mixtures thereof. The acids per se may also be used. Besides their building effect, the acids also typically have the property of an acidifying component and, hence, also serve to establish a relatively low and mild pH value in detergents or cleaners. Citric acid, succinic acid, glutaric acid, adipic acid, gluconic acid and mixtures thereof are particularly mentioned in this regard.

Other suitable organic builders are dextrins, for example oligomers or polymers of carbohydrates which may be obtained by partial hydrolysis of starches. The hydrolysis may be carried out by standard methods, for example acid- or enzyme-catalyzed methods. The end products are preferably hydrolysis products with average molecular weights of 400 to 500,000. A polysaccharide with a dextrose equivalent (DE) of 0.5 to 40 and, more particularly, 2 to 30 is preferred, the DE being an accepted measure of the reducing effect of a polysaccharide by comparison with dextrose which has a DE of 100. Both maltodextrins with a DE of 3 to 20 and dry glucose syrups with a DE of 20 to 37 and also so-called yellow dextrins and white dextrins with relatively high molecular weights of 2,000 to 30,000 may be used. A preferred dextrin is described in British patent application 94 19 091 A1. The oxidized derivatives of such dextrins are their reaction products with oxidizing agents which are capable of oxidizing at least one alcohol function of the saccharide ring to the carboxylic acid function. Dextrins thus oxidized and processes for their production are known, for example, from European patent applications EP 0 232 202 A1, EP 0 427 349 A1, EP 0 472 042 A1 and EP 0 542 496 A1 and from International patent applications WO 92/18542, WO 93/08251, WO 93/16110, WO 94/28030, WO 95/07303, WO 95/12619 and WO 95/20608. An oxidized oligosaccharide corresponding to German patent application DE 196 00 018 A1 is also suitable. A product oxidized at C₆ of the saccharide ring can be particularly advantageous.

Other suitable co-builders are oxydisuccinates and other derivatives of disuccinates, preferably ethylenediamine disuccinate. The glycerol disuccinates and glycerol trisuccinates described, for example, in U.S. Pat. No. 4,524,009, in U.S. Pat. No. 4,639,325, in European patent application EP 0 150 930 A1 and in Japanese patent application JP 93/339896 are also particularly preferred in this connection. The quantities used in zeolite-containing and/or silicate-containing formulations are from 3 to 15% by weight.

Other useful organic co-builders are, for example, acetylated hydroxycarboxylic acids and salts thereof which may optionally be present in lactone form and which contain at least 4 carbon atoms, at least one hydroxy group and at most two acid groups. Co-builders such as these are described, for example, in International patent application WO 95/20029.

Suitable polymeric polycarboxylates are, for example, the sodium salts of polyacrylic acid or polymethacrylic acid, for example those with a relative molecular weight of 800 to 150,000 (based on acid and measured against polystyrenesulfonic acid). Suitable copolymeric polycarboxylates are, in particular, those of acrylic acid with methacrylic acid and of acrylic acid or methacrylic acid with maleic acid. Acrylic acid/maleic acid copolymers containing 50 to 90% by weight of acrylic acid and 50 to 10% by weight of maleic acid have proved to be particularly suitable. Their relative molecular weight, based on free acids, is generally in the range from 5,000 to 200,000, preferably in the range from 10,000 to 120,000 and more preferably in the range from 50,000 to 100,000 (as measured against polystyrenesulfonic acid). The (co)polymeric polycarboxylates may be used either as powders or as aqueous solutions, 20 to 55% by weight aqueous solutions being preferred. Granular polymers are generally added to basic granules of one or more types in a subsequent step. Also particularly preferred are biodegradable polymers of more than two different monomer units, for example those which contain salts of acrylic acid and maleic acid and vinyl alcohol or vinyl alcohol derivatives as monomers in accordance with DE 43 00 772 A1 or salts of acrylic acid and 2-alkylallyl sulfonic acid and sugar derivatives as monomers in accordance with DE 42 21 381 C2. Other preferred copolymers are those described in German patent applications DE 43 03 320 A1 and DE 44 17 734 A1 which preferably contain acrolein and acrylic acid/acrylic acid salts or acrolein and vinyl acetate as monomers. Other preferred builders are polymeric aminodicarboxylic acids, salts and precursors thereof. Polyaspartic acids and salts and derivatives thereof are particularly preferred.

Other suitable builders are polyacetals which may be obtained by reaction of dialdehydes with polyol carboxylic acids containing 5 to 7 carbon atoms and at least three hydroxyl groups, for example as described in European patent application EP 0 280 223 A1. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

In addition, the detergents/cleaners may contain components with a positive effect on the removability of oil and fats from textiles by washing. Preferred oil- and fat-dissolving components include, for example, nonionic cellulose ethers, such as methyl cellulose and methyl hydroxypropyl cellulose containing 15 to 30% by weight of methoxyl groups and 1 to 15% by weight of hydroxypropoxyl groups, based on the nonionic cellulose ether, and the polymers of phthalic acid and/or terephthalic acid known from the prior art or derivatives thereof, more particularly polymers of ethylene terephthalates and/or polyethylene glycol terephthalates or anionically and/or nonionically modified derivatives thereof. Of these, the sulfonated derivatives of phthalic acid and terephthalic acid polymers are particularly preferred.

Other suitable ingredients of the detergents/cleaners are water-soluble inorganic salts, such as bicarbonates, carbonates, amorphous silicates, normal waterglasses with no pronounced builder properties or mixtures thereof. One particular embodiment is characterized by the use of alkali metal carbonate and/or amorphous alkali metal silicate, above all sodium silicate with a molar Na₂O:SiO₂ ratio of 1:1 to 1:4.5 and preferably 1:2 to 1:3.5. The sodium carbonate content of the final detergents/cleaning compositions is preferably up to 40% by weight and advantageously from 2 to 35% by weight. The content of sodium silicate (without particular building properties) in the detergents/cleaning compositions is generally up to 10% by weight and preferably between 1 and 8% by weight.

Among the compounds yielding H₂O₂ in water which serve as bleaching agents, sodium perborate tetrahydrate and sodium perborate monohydrate are particularly important. Other useful bleaching agents are, for example, sodium percarbonate, peroxypyrophosphates, citrate perhydrates and H₂O₂-yielding peracidic salts or peracids, such as perbenzoates, peroxophthalates, diperazelaic acid, phthaloiminoperacid or diperdodecanedioic acid. The content of peroxy bleaching agents in the detergents/cleaners is preferably 5 to 35% by weight and more preferably up to 30% by weight, perborate monohydrate or percarbonate advantageously being used.

Suitable bleach activators are compounds which form aliphatic peroxocarboxylic acids containing preferably 1 to 10 carbon atoms and more preferably 2 to 4 carbon atoms and/or optionally substituted perbenzoic acid under perhydrolysis conditions. Substances bearing O- and/or N-acyl groups with the number of carbon atoms mentioned and/or optionally substituted benzoyl groups are suitable. Preferred bleach activators are polyacylated alkylenediamines, more particularly tetraacetyl ethylenediamine (TAED), acylated triazine derivatives, more particularly 1,5-diacetyl-2,4-dioxohexahydro-1,3,5-triazine (DADHT), acylated glycolurils, more particularly tetraacetyl glycoluril (TAGU), N-acylimides, more particularly N-nonanoyl succinimide (NOSI), acylated phenol sulfonates, more particularly n-nonanoyl or isononanoyloxybenzenesulfonate (n- or iso-NOBS), carboxylic anhydrides, more particularly phthalic anhydride, acylated polyhydric alcohols, more particularly triacetin, ethylene glycol diacetate, 2,5-diacetoxy-2,5-dihydrofuran and the enol esters known from German patent applications DE 196 16 693 A1 and DE 196 16 767 A1, acetylated sorbitol and mannitol and the mixtures thereof (SORMAN) described in European patent application EP 0 525 239 A1, acylated sugar derivatives, more particularly pentaacetyl glucose (PAG), pentaacetyl fructose, tetraacetyl xylose and octaacetyl lactose, and acetylated, optionally N-alkylated glucamine and gluconolactone, and/or N-acylated lactams, for example N-benzoyl caprolactam, which are known from International patent applications WO 94/27970, WO 94/28102, WO 94/28103, WO 95/00626, WO 95/14759 and WO 95/17498. The substituted hydrophilic acyl acetals known from German patent application DE 196 16 769 A1 and the acyl lactams described in German patent application DE 196 16 770 and in International patent application WO 95/14075 are also preferably used. The combinations of conventional bleach activators known from German patent application DE 44 43 177 A1 may also be used. Bleach activators such as these are present in the usual quantities, preferably in quantities of 1% by weight to 10% by weight and more preferably in quantities of 2% by weight to 8% by weight, based on the detergent/cleaning composition as a whole. In addition to or instead of the conventional bleach activators mentioned above, the sulfonimines known from European patents EP 0 446 982 B1 and EP 0 453 003 B1 and/or bleach-boosting transition metal salts or transition metal complexes may also be present as so-called bleach catalysts. Suitable transition metal compounds include, in particular, the manganese-, iron-, cobalt-, ruthenium- or molybdenum-salen complexes known from German patent application DE 195 29 905 A1 and the N-analog compounds thereof known from German patent application DE 196 20 267 A1, the manganese-, iron-, cobalt-, ruthenium- or molybdenum-carbonyl complexes known from German patent application DE 195 36 082 A1, the manganese, iron, cobalt, ruthenium, molybdenum, titanium, vanadium and copper complexes with nitrogen-containing tripod ligands described in German patent application DE 196 05 688 A1, the cobalt-, iron-, copper- and ruthenium-ammine complexes known from German patent application DE 196 20 411 A1, the manganese, copper and cobalt complexes described in German patent application DE 44 16 438 A1, the cobalt complexes described in European patent application EP 0 272 030 A1, the manganese complexes known from European patent application EP 0 693 550 A1, the manganese, iron, cobalt and copper complexes known from European patent EP 0 392 592 A1 and/or the manganese complexes described in European patent EP 0 443 651 B1 or in European patent applications EP 0 458 397 A1, EP 0 458 398 A1, EP 0 549 271 A1, EP 0 549 272 A1, EP 0 544 490 A1 and EP 0 544 519 A1. Combinations of bleach activators and transition metal bleach catalysts are known, for example, from German patent application DE 196 13 103 A1 and from international patent application WO 95/27775. Bleach-boosting transition metal complexes, more particularly with the central atoms Mn, Fe, Co. Cu, Mo. V, Ti and/or Ru, are used in typical quantities, preferably in a quantity of up to 1% by weight, more preferably in a quantity of 0.0025% by weight to 0.25% by weight and most preferably in a quantity of 0.01% by weight to 0.1% by weight, based on the detergent/cleaner as a whole.

Suitable enzymes are, in particular, enzymes from the class of hydrolases, such as proteases, esterases, lipases or lipolytic enzymes, amylases, cellulases or other glycosyl hydrolases and mixtures thereof. All these hydrolases contribute to the removal of stains, such as protein-containing, fat-containing or starch-containing stains, and discoloration in the washing process. Cellulases and other glycosyl hydrolases can contribute towards color retention and towards increasing fabric softness by removing pilling and microfibrils. Oxidoreductases may also be used for bleaching and for inhibiting dye transfer. Enzymes obtained from bacterial strains or fungi, such as Bacillus subtilis, Bacillus licheniformis, Streptomyces griseus and Humicola insolens are particularly suitable. Proteases of the subtilisin type are preferably used, proteases obtained from Bacillus lentus being particularly preferred. Of particular interest in this regard are enzyme mixtures, for example of protease and amylase or protease and lipase or lipolytic enzymes or protease and cellulase or of cellulase and lipase or lipolytic enzymes or of protease, amylase and lipase or lipolytic enzymes or protease, lipase or lipolytic enzymes and cellulase, but especially protease- and/or lipase-containing mixtures or mixtures with lipolytic enzymes. Examples of such lipolytic enzymes are the known cutinases. Peroxidases or oxidases have also been successfully used in some cases. Suitable amylases include in particular α-amylases, isoamylases, pullanases and pectinases. Preferred cellulases are cellobiohydrolases, endoglucanases and β-glucosidases, which are also known as cellobiases, and mixtures thereof. Since the various cellulase types differ in their CMCase and avicelase activities, the desired activities can be established by mixing the cellulases in the appropriate ratios. The enzymes may be adsorbed to supports and/or encapsulated in membrane materials to protect them against premature decomposition. The percentage content of enzymes, enzyme mixtures or enzyme granules may be, for example, about 0.1 to 5% by weight and is preferably from 0.1 to about 2% by weight.

In addition to the monohydric and polyhydric alcohols, the detergents/cleaners may contain other enzyme stabilizers. For example, 0.5 to 1% by weight of sodium formate may be used. Proteases stabilized with soluble calcium salts and having a calcium content of preferably about 1.2% by weight, based on the enzyme, may also be used. Apart from calcium salts, magnesium salts also serve as stabilizers. However, it is of particular advantage to use boron compounds, for example boric acid, boron oxide, borax and other alkali metal borates, such as the salts of orthoboric acid (H₃BO₃), metaboric acid (HBO₂) and pyroboric acid (tetraboric acid H₂B₄O₇).

The function of redeposition inhibitors is to keep the soil detached from the fibers suspended in the wash liquor and thus to prevent the soil from being re-absorbed by the washing. Suitable redeposition inhibitors are water-soluble, generally organic colloids, for example the water-soluble salts of polymeric carboxylic acids, glue, gelatine, salts of ether carboxylic acids or ether sulfonic acids of starch or cellulose or salts of acidic sulfuric acid esters of cellulose or starch. Water-soluble polyamides containing acidic groups are also suitable for this purpose. Soluble starch preparations and other starch products than those mentioned above, for example degraded starch, aldehyde starches, etc., may also be used. Polyvinyl pyrrolidone is also suitable. However, cellulose ethers, such as carboxymethyl cellulose (sodium salt), methyl cellulose, hydroxyalkyl cellulose, and mixed ethers, such as methyl hydroxyethyl cellulose, methyl hydroxypropyl cellulose, methyl carboxymethyl cellulose and mixtures thereof, and polyvinyl pyrrolidone are also preferably used, for example in quantities of 0.1 to 5% by weight, based on the detergent/cleaner.

The detergents/cleaners may contain derivatives of diaminostilbene disulfonic acid or alkali metal salts thereof as optical brighteners. Suitable optical brighteners are, for example, salts of 4,4′-bis-(2-anilino-4-morpholino-1,3,5-triazinyl-6-amino)-stilbene-2,2′-disulfonic acid or compounds of similar structure which contain a diethanolamino group, a methylamino group and anilino group or a 2-methoxyethylamino group instead of the morpholino group. Brighteners of the substituted diphenyl styryl type, for example alkali metal salts of 4,4′-bis-(2-sulfostyryl)-diphenyl, 4,4′-bis-(4-chloro-3-sulfostyryl)-diphenyl or 4-(4-chlorostyryl)-4′-(2-sulfostyryl)-diphenyl, may also be present. Mixtures of the brighteners mentioned may also be used. Uniformly white granules are obtained if, in addition to the usual brighteners in the usual quantities, for example between 0.1 and 0.5% by weight and preferably between 0.1 and 0.3% by weight, the detergents/cleaners also contain small quantities, for example 10⁻⁶ to 10⁻³% by weight and preferably around 10⁻⁵% by weight, of a blue dye. A particularly preferred dye is Tinolux® (a product of Ciba-Geigy).

Suitable soil repellents are substances which preferably contain ethylene terephthalate and/or polyethylene glycol terephthalate groups, the molar ratio of ethylene terephthalate to polyethylene glycol terephthalate being in the range from 50:50 to 90:10. The molecular weight of the linking polyethylene glycol units is more particularly in the range from 750 to 5,000, i.e. the degree of ethoxylation of the polymers containing polyethylene glycol groups may be about 15 to 100. The polymers are distinguished by an average molecular weight of about 5,000 to 200,000 and may have a block structure, but preferably have a random structure. Preferred polymers are those with molar ethylene terephthalate: polyethylene glycol terephthalate ratios of about 65:35 to about 90:10 and preferably in the range from about 70:30 to 80:20. Other preferred polymers are those which contain linking polyethylene glycol units with a molecular weight of 750 to 5,000 and preferably in the range from 1,000 to about 3,000 and which have a molecular weight of the polymer of about 10,000 to about 50,000. Examples of commercially available polymers are the products Milease® T (ICI) or Repelotex® SRP 3 (Rhône-Poulenc).

Wax-like compounds may be used as defoamers. “Wax-like” compounds are understood to be compounds which have a melting point at atmospheric pressure above 25° C. (room temperature), preferably above 50° C. and more preferably above 70° C. The wax-like defoamers are substantially insoluble in water, i.e. their solubility in 100 g of water at 20° C. is less than 0.1% by weight. In principle, any wax-like defoamers known from the prior art may additionally be present. Suitable wax-like compounds are, for example, bisamides, fatty alcohols, fatty acids, carboxylic acid esters of monohydric and polyhydric alcohols and paraffin waxes or mixtures thereof. Alternatively, the silicone compounds known for this purpose may of course also be used.

Suitable paraffin waxes are generally a complex mixture with no clearly defined melting point. For characterization, its melting range is normally determined by differential thermoanalysis (DTA), as described in “The Analyst” 87 (1962), 420, and/or its solidification point is determined. The solidification point is understood to be the temperature at which the paraffin changes from the liquid state into the solid state by slow cooling. Paraffins which are entirely liquid at room temperature, i.e. paraffins with a solidification point below 25° C., are not suitable for use in accordance with the invention. It is possible, for example, to use the paraffin wax mixtures known from EP 0309931 A1 of, for example, 26% by weight to 49% by weight of microcrystalline paraffin wax with a solidification point of 62° C. to 90° C., 20% by weight to 49% by weight of hard paraffin with a solidification point of 42° C. to 56° C. and 2% by weight to 25% by weight of soft paraffin with a solidification point of 35° C. to 40° C. Paraffins or paraffin mixtures which solidify at temperatures of 30° C. to 90° C. are preferably used. It is important in this connection to bear in mind that even paraffin wax mixtures which appear solid at room temperature may contain different amounts of liquid paraffin. In the paraffin waxes suitable for use in accordance with the invention, this liquid component is as small as possible and is preferably absent altogether. Thus, particularly preferred paraffin wax mixtures have a liquid component at 30° C. of less than 10% by weight and, more particularly, from 2% by weight to 5% by weight, a liquid component at 40° C. of less than 30% by weight, preferably from 5% by weight to 25% by weight and more preferably from 5% by weight to 15% by weight, a liquid component at 60° C. of 30% by weight to 60% by weight and preferably 40% by weight to 55% by weight, a liquid component at 80° C. of 80% by weight to 100% by weight and a liquid component at 90° C. of 100% by weight. In particularly preferred paraffin wax mixtures, the temperature at which a liquid component of 100% by weight of the paraffin wax is reached is still below 85° C. and, more particularly, between 75° C. and 82° C. The paraffin waxes may be petrolatum, microcrystalline waxes or hydrogenated or partly hydrogenated paraffin waxes.

Bisamides suitable as defoamers are those derived from saturated fatty acids containing 12 to 22 and preferably 14 to 18 carbon atoms and from alkylenediamines containing 2 to 7 carbon atoms. Suitable fatty acids are lauric acid, myristic acid, stearic acid, arachic acid and behenic acid and the mixtures thereof obtainable from natural fats or hydrogenated oils, such as tallow or hydrogenated palm oil. Suitable diamines are, for example, ethylenediamine, 1,3-propylenediamine, tetramethylenediamine, pentamethylenediamine, hexamethylenediamine, p-phenylenediamine and toluylenediamine. Preferred diamines are ethylenediamine and hexamethylenediamine. Particularly preferred bisamides are bis-myristoyl ethylenediamine, bis-palmitoyl ethylenediamine, bis-stearoyl ethylenediamine and mixtures thereof and the corresponding derivatives of hexamethylenediamine.

Suitable carboxylic acid esters as defoamers are derived from carboxylic acids containing 12 to 28 carbon atoms. The esters in question are, in particular, esters of behenic acid, stearic acid, hydroxystearic acid, oleic acid, palmitic acid, myristic acid and/or lauric acid. The alcohol moiety of the carboxylic acid ester contains a monohydric or polyhydric alcohol containing 1 to 28 carbon atoms in the hydrocarbon chain. Examples of suitable alcohols are behenyl alcohol, arachidyl alcohol, coconut alcohol, 12-hydroxystearyl alcohol, oleyl alcohol and lauryl alcohol and ethylene glycol, glycerol, polyvinylvinyl alcohol, sucrose, erythritol, pentaerythritol, sorbitan and/or sorbitol. Preferred esters are esters of ethylene glycol, glycerol and sorbitan, the acid moiety of the ester being selected in particular from behenic acid, stearic acid, oleic acid, palmitic acid or myristic acid. Suitable esters of polyhydric alcohols are, for example, xylitol monopalmitate, pentaerythritol monostearate, glycerol monostearate, ethylene glycol monostearate and sorbitan monostearate, sorbitan palmitate, sorbitan monolaurate, sorbitan dilaurate, sorbitan distearate, sorbitan dibehenate, sorbitan dioleate and mixed tallow alkyl sorbitan monoesters and diesters. Suitable glycerol esters are the mono-, di- or triesters of glycerol and the carboxylic acids mentioned, the monoesters and diesters being preferred. Glycerol monostearate, glycerol monooleate, glycerol monopalmitate, glycerol monobehenate and glycerol distearate are examples. Examples of suitable natural esters as defoamers are beeswax, which mainly consists of the esters CH₃(CH₂)₂₄COO(CH₂)₂₇CH₃ and CH₃(CH₂)₂₆COO(CH₂)₂₅CH₃, and carnauba wax, carnauba wax being a mixture of carnauba acid alkyl esters, often in combination with small amounts of free carnauba acid, other long-chain acids, high molecular weight alcohols and hydrocarbons.

Suitable carboxylic acids as another defoamer compound are, in particular, behenic acid, stearic acid, oleic acid, palmitic acid, myristic acid and lauric acid and the mixtures thereof obtainable from natural fats or optionally hydrogenated oils, such as tallow or hydrogenated palm oil. Saturated fatty acids containing 12 to 22 and, more particularly, 18 to 22 carbon atoms are preferred.

Suitable fatty alcohols as another defoamer compound are the hydrogenated products of the described fatty acids.

Dialkyl ethers may also be present as defoamers. The ethers may have an asymmetrical or symmetrical structure, i.e. they may contain two identical or different alkyl chains, preferably containing 8 to 18 carbon atoms. Typical examples are di-n-octyl ether, di-i-octyl ether and di-n-stearyl ether, dialkyl ethers with a melting point above 25° C. and more particularly above 40° C. being particularly suitable.

Other suitable defoamer compounds are fatty ketones which may be obtained by the relevant methods of preparative organic chemistry. They are produced, for example, from carboxylic acid magnesium salts which are pyrolyzed at temperatures above 300° C. with elimination of carbon dioxide and water, for example in accordance with DE 2553900 OS. Suitable fatty ketones are produced by pyrolysis of the magnesium salts of lauric acid, myristic acid, palmitic aid, palmitoleic acid, stearic acid, oleic acid, elaidic acid, petroselic acid, arachic acid, gadoleic acid, behenic acid or erucic acid.

Other suitable defoamers are fatty acid polyethylene glycol esters which are preferably obtained by the homogeneously base-catalyzed addition of ethylene oxide onto fatty acids. The addition of ethylene oxide onto the fatty acids takes place in particular in the presence of alkanolamines as catalysts. The use of alkanolamines, especially triethanolamine, leads to extremely selective ethoxylation of the fatty acids, particularly where it is desired to produce compounds with a low degree of ethoxylation. Within the group of fatty acid polyethylene glycol esters, those with a melting point above 25° C. and more particularly above 40° C. are preferred.

Within the group of wax-like defoamers, the described paraffin waxes—in a particularly preferred embodiment—are used either on their own as wax-like defoamers or in admixture with one of the other wax-like defoamers, the percentage content of the paraffin waxes in the mixture preferably exceeding 50% by weight, based on the wax-like defoamer mixture. If necessary, the paraffin waxes may be applied to supports. Suitable support materials in the context of the present invention are any known inorganic and/or organic support materials. Examples of typical inorganic support materials are alkali metal carbonates, alumosilicates, water-soluble layer silicates, alkali metal silicates, alkali metal sulfates, for example sodium sulfate, and alkali metal phosphates. The alkali metal silicates are preferably a compound with a molar ratio of alkali metal oxide to SiO₂ of 1:1.5 to 1:3.5. The use of silicates such as these results in particularly good particle properties, more particularly high abrasion resistance and at the same time a high dissolving rate in water. Alumosilicates as a support material include, in particular, the zeolites, for example zeolite NaA and NaX. The compounds described as water-soluble layer silicates include, for example, amorphous or crystalline waterglass. Silicates commercially available as Aerosil® or Sipernat® may also be used. Suitable organic carrier materials are, for example, film-forming polymers, for example polyvinyl alcohols, polyvinyl pyrrolidones, poly(meth)acrylates, polycarboxylates, cellulose derivatives and starch. Suitable cellulose ethers are, in particular, alkali metal carboxymethyl cellulose, methyl cellulose, ethyl cellulose, hydroxyethyl cellulose and so-called cellulose mixed ethers, for example methyl hydroxyethyl cellulose and methyl hydroxypropyl cellulose, and mixtures thereof. Particularly suitable mixtures are mixtures of sodium carboxymethyl cellulose and methyl cellulose, the carboxymethyl cellulose normally having a degree of substitution of 0.5 to 0.8 carboxymethyl groups per anhydroglucose unit while the methyl cellulose has a degree of substitution of 1.2 to 2 methyl groups per anhydroglucose unit. The mixtures preferably contain alkali metal carboxymethyl cellulose and nonionic cellulose ether in ratios by weight of 80:20 to 40:60 and, more particularly, 75:25 to. 50:50. Another suitable support is native starch which is made up of amylose and amylopectin. Native starch is starch obtainable as an extract from natural sources, for example from rice, potatoes, corn and wheat. Native starch is a standard commercial product and is therefore readily available. Suitable support materials are individual compounds or several of the compounds mentioned above selected in particular from the group of alkali metal carbonates, alkali metal sulfates, alkali metal phosphates, zeolites, water-soluble layer silicates, alkali metal silicates, polycarboxylates, cellulose ethers, polyacrylate/polymethacrylate and starch. Mixtures of alkali metal carbonates, more particularly sodium carbonate, alkali metal silicates, more particularly sodium silicate, alkali metal sulfates, more particularly sodium sulfate, and zeolites are particularly suitable.

Suitable silicones are typical organopolysiloxanes containing fine-particle silica which, in turn, may even be silanized. Corresponding organopolysiloxanes are described, for example, in European patent application EP 0 496 510 A1. Polydiorganosiloxanes known from the prior art are particularly preferred. However, siloxane-crosslinked compounds known to the expert as silicone resins may also be used. The polydiorganosiloxanes generally contain fine-particle silica which may even be silanized. Silica-containing dimethyl polysiloxanes are particularly suitable for the purposes of the present invention. The polydiorganosiloxanes advantageously have a Brookfield viscosity at 25° C. of 5000 mPas to 30,000 mPas and, more particularly, 15,000 mPas to 25,000 mPas. The silicones are preferably applied to support materials. Suitable support materials were described above in connection with the paraffins. The support materials are generally present in quantities of 40 to 90% by weight and preferably in quantities of 45 to 75% by weight, based on defoamer.

In addition, solid preparations may contain co-disintegrators, such as polyvinyl pyrrolidone, collodion, alginic acid and alkali metal salts thereof, amorphous or even partly crystalline layer silicates (bentonites), polyurethanes, polyethylene glycols and effervescent systems.

The detergents/cleaners may contain proteins and protein derivatives which significantly improve the dissolving rate of the surfactant mixtures according to the invention. Reference is specifically made here to unpublished patent application DE 19956802 of which the disclosure is also being made part of the disclosure of the present invention.

The protein component is preferably formed by protein hydrolyzates and condensation products thereof with fatty acids and, to a lesser extent, by protein hydrolyzate esters and quaternized protein fatty acid condensates. Protein hydrolyzates are degradation products of animal or vegetable proteins, for example collagen, elastin or keratin, preferably almond and potato protein and more particularly wheat, rice and soya protein, which are obtained by acidic, alkaline and/or enzymatic hydrolysis and thereafter have an average molecular weight of 600 to 4,000 and preferably 2,000 to 3,500. Although protein hydrolyzates are not surfactants in the accepted sense because they lack a hydrophobic residue, they are often used for formulating surface-active compositions by virtue of their dispersing properties. Overviews of the production and use of protein hydrolyzates have been published, for example, by G. Schuster and A. Domsch in Seifen, Öle, Fette, Wachse, 108, 177 (1982) and Cosm. Toil. 99, 63 (1984), by H. W. Steisslinger in Parf. Kosm. 72, 556 (1991) and by F. Aurich et al. in Tens. Surf. Det. 29, 389 (1992). Vegetable protein hydrolyzates based on wheat gluten or rice protein, of which the production is described in German patents DE-C1 19502167 and DE-C1 19502168 (Henkel), are preferably used. So-called protein fatty acid condensates which are comparable in their properties with soaps can be obtained from the protein hydrolyzates by condensation with C₆₋₂₂, preferably C₁₂₋₁₈ fatty acids. Condensates of the above-mentioned hydrolyzates with caproic acid, caprylic acid, 2-ethyl hexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid are preferably used.

Suitable perfume oils or perfumes include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert.butyl cyclohexyl acetate, linalyl acetate, dimethyl benzyl carbinyl acetate, phenyl ethyl acetate, linalyl benzoate, benzyl formate, ethyl methyl phenyl glycinate, allyl cyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenyl ethyl alcohol and terpineol and the hydrocarbons include, above all, the terpenes, such as limonene and pinene. However, mixtures of various perfumes which together produce an attractive perfume note are preferably used. Perfume oils such as these may also contain natural perfume mixtures obtainable from vegetable sources, for example pine, citrus, jasmine, patchouli, rose or ylang-ylang oil. Also suitable are clary oil, camomile oil, clove oil, melissa oil, mint oil, cinnamon leaf oil, lime blossom oil, juniper berry oil, vetiver oil, olibanum oil, galbanum oil and ladanum oil and orange blossom oil, neroli oil, orange peel oil and sandalwood oil. The perfumes may be directly incorporated in the detergents/cleaners according to the invention, although it can also be of advantage to apply the perfumes to supports which strengthen the adherence of the perfume to the washing and which provide the textiles with a long-lasting fragrance through a slower release of the perfume. Suitable support materials are, for example, cyclodextrins, the cyclodextrin/perfume complexes optionally being coated with other auxiliaries.

If desired, the final preparations may also contain inorganic salts, for example sodium sulfate, as a filler, preferably in quantities of 0 to 10% by weight and more particularly in quantities of 1 to 5% by weight, based on detergent/cleaner.

In a preferred embodiment, the laundry detergents, dishwashing detergents and cleaners contain the surfactant mixture according to the invention as granules, surfactants and disintegrators being present in a ratio by weight of 1:10 to 10:1, preferably 1:5 to 5:1 and more particularly 1:2 to 2:1.

Detergent tablets, solid powder-form detergents, more particularly compactates and supercompactates, and liquid, paste-form and/or gel-form detergents containing the surfactant mixtures according to the invention and other ingredients are preferred.

Detergent Tablets

The present invention relates to detergent tablets containing 0.1 to 90% by weight and preferably 1 to 60% by weight of the surfactant mixture according to the invention, 0 to 50% by weight of other nonionic surfactants, 0 to 10% by weight of cationic surfactants, 0 to 10% by weight of amphoteric surfactants, 0 to 35% by weight of bleaching agents, 0 to 70% by weight of builders, 0.1 to 25% by weight of disintegrators and 0 to 25% by weight of defoamers—based on the tablet—and optionally other auxiliaries and additives.

The production of shaped bodies, preferably those in tablet form, is generally carried out by tabletting or press agglomeration. The particulate press agglomerates obtained may either be directly used as detergents or may be aftertreated beforehand by conventional methods. Conventional aftertreatments include, for example, powdering with fine-particle detergent ingredients which, in general, produces a further increase in bulk density. However, another preferred aftertreatment is the procedure according to German patent applications DE 195 24 287 A1 and DE 195 47 457 A1, according to which dust-like or at least fine-particle ingredients (so-called fine components) are bonded to the particulate end products produced in accordance with the invention which serve as core. This results in the formation of detergents which contain these so-called fine components as an outer shell. Advantageously, this is again done by melt agglomeration. On the subject of the melt agglomeration of fine components, reference is specifically made to the disclosure of German patent applications DE-A-195 24 287 and DE-A-195 47 457. In the preferred embodiment of the invention, the solid detergents are present in tablet form, the tablets preferably having rounded corners and edges, above all in the interests of safer storage and transportation. The base of the tablets may be, for example, circular or rectangular in shape. Multilayer tablets, particularly tablets containing two or three layers which may even have different colors, are particularly preferred. The colors blue, green, white, pink and combinations thereof are particularly preferred. The tablets may also have compressed and non-compressed parts. Tablets with a particularly advantageous dissolving rate are obtained if, before compression, the granular constituents contain less than 20% by weight and preferably less than 10% by weight of particles outside the 0.02 to 6 mm diameter range. A particle size distribution of 0.05 to 2.0 mm is preferred, a particle size distribution of 0.2 to 1.0 mm being particularly preferred.

Block-like shaped bodies (soap bars) may also be regarded as a possible special embodiment.

Solid Powder-Form Detergents

Solid powder-form detergents are generally divided into heavy-duty and light-duty detergents. They may be further divided into normal powders, compactates and supercompactates according to their bulk density. A normal powder of a heavy-duty detergent has a bulk density of 450 to 500 g/l, a compactate one of 500 to 650 g/l and a supercompactate one of more than 650 g/l. In the case of powder-form light-duty detergents, the normal powders have a bulk density of 250 to 400 g/l, compactates one of 400 to 650 g/l and supercompactates one of more than 650 g/l. Solid powder-form detergents are specifically understood to be granules, extrudates, powders and agglomerates.

The present invention also relates to solid powder-form detergents containing 0.1 to 90% by weight and preferably 1 to 60% by weight of the surfactant mixture according to the invention, 0 to 50% by weight of other nonionic surfactants, 0 to 35% by weight of bleaching agents, 0 to 70% by weight of builders, 0 to 25% by weight of defoamers and 0 to 5% by weight of disintegrators—based on the detergent—and optionally other auxiliaries and additives.

Liquid, Paste-Form and Gel-Form Detergents

The present invention also relates to liquid, paste-form and/or gel form detergents containing 0.1 to 90% by weight and preferably 5 to 70% by weight of the surfactant mixture according to the invention, 10 to 99% by weight of water, 0 to 50% by weight of other nonionic surfactants, 0 to 10% by weight of builders and 0 to 25% by weight of defoamers, based on the detergent.

Liquid detergents contain at least 10% by weight of water and paste-form detergents have a solids content of 10 to 70% by weight. Gel-form detergents are understood to be detergents which contain less than 50% by weight of water and which are distinguished by a high stable viscosity in contrast to liquid detergents. A definition of what is meant by stable viscosity can be found in DE 19752165. Conventional liquid detergents are normally converted into relatively high viscosity products by the use of thickeners, such as agar agar, carrageen, tragacanth, gum arabic, alginates, pectins, polyoses, guar gum, locust bean gum, starch, dextrins, gelatin, casein, carboxymethyl cellulose and other cellulose ethers, hydroxyethyl and hydroxypropyl cellulose and the like, gum ethers, polyacrylic and polymethacrylic compounds, vinyl polymers, polycarboxylic acids, polyethers, polyimines, polyamides, polysilicic acids, clay minerals, such as montmorillonites, zeolites and silicas, and simultaneous adaptation of the type and quantity of the individual ingredients.

The liquid, paste-form and gel-form detergents also contain nonaqueous solvents. Nonaqueous solvents which may be used in the detergents according to the invention belong, for example, to the group of mono- or polyhydric alcohols, alkanolamines or glycolethers providing they are miscible with water in the stated concentration range. The solvents are preferably selected from ethanol, n- or i-propanol, butanols, glycol, propanediol or butanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or ethyl ether, diisopropylene glycol monomethyl or ethyl ether, methoxy, ethoxy or butoxy triglycol, 1-butoxyethoxy-2-propanol, 3-methyl-3-methoxybutanol, propylene glycol-t-butyl ether and mixtures of these solvents. Nonaqueous solvents may be present in the liquid detergents according to the invention in quantities of 0.5 to 20% by weight, preferably in quantities of 5 to 15% by weight and more particularly in quantities below 10% by weight. Reference is made in particular to patent applications DE 19752163 and DE 19752165 of which the disclosures are also being made part of the disclosure of the present invention.

The laundry/dishwashing detergents and cleaners are produced in the same way as described in patent application DE 10003124 for the production of surfactant granules. The shaped bodies produced in this way, such as granules, powders, compactates, supercompactates, extrudates and agglomerates, may be processed with other ingredients and the corresponding auxiliaries and additives as solid laundry detergents, dishwashing detergents and cleaners. Such compositions are produced by the corresponding processes known from the prior art. They are preferably produced by mixing together various particulate components containing detergent ingredients. The particulate components may be produced by spray drying, simple mixing or complex granulation processes, for example fluidized bed granulation. In one particularly preferred embodiment, at least surfactant-containing component is produced by fluidized bed granulation. In another particularly preferred embodiment, aqueous preparations of the alkali metal silicate and alkali metal carbonate are sprayed in a dryer with other detergent ingredients, the drying process optionally being accompanied by granulation.

Liquid or paste-form and/or gel-form laundry detergents, dishwashing detergents and cleaners are produced simply by mixing the surfactant mixtures according to the invention with water and optionally thickeners, nonaqueous solvents, co-surfactants and auxiliaries and additives in a stirred tank.

In a preferred embodiment, the detergent tablets and/or the solid powder-form, gel-form, liquid or paste-form detergents contain only 0.5 to 5% by weight, preferably 0.6 to 4% by weight and more particularly 0.7 to 3% by weight, based on the tablet or detergent, of defoamers. By using the surfactant mixture according to the invention in laundry/dishwashing detergents and cleaners, the formulation can be defoamed with considerably smaller quantities of defoamers. It is particularly preferred to use paraffin-based defoamers which are preferably silicone-free.

Commercial Applications

The present invention relates to the use of the surfactant mixtures according to the invention in liquid, paste-form and/or gel-form laundry detergents, dishwashing detergents and cleaners for the home and the industrial and institutional sectors.

In a particularly preferred embodiment, the surfactant mixtures according to the invention are preferably used in heavy-duty and speciality detergents, such as light-duty detergents, wool and color detergents and curtain detergents and in cleaning compositions for hard surfaces, such as all-purpose cleaners, manual and machine dishwashing detergents, floor cleaners, bathroom cleaners, toilet cleaners, car cleaners, and in hand washing pastes.

The present invention also relates to the use of the surfactant mixtures according to the invention in solid laundry detergents, dishwashing detergents and cleaners, The products in question are preferably both heavy-duty detergents and speciality detergents, such as light-duty detergents, wool and color detergents and curtain detergents, in the form of granules, powders, compactates, supercompactates, extrudates and agglomerates, but also cleaning compositions for hard surfaces, such as all-purpose cleaners, manual and machine dishwashing detergents, floor cleaners, bathroom cleaners, toilet cleaners, interior/exterior car cleaners and solid cleaners (block cleaners and soap bars).

“Solid cleaners” are understood to be cleaners which are used in solid form, preferably in the form of blocks, for example as soap bars. Block cleaners may also be used in special dosing units for the preparation of individual cleaning mixtures. In this application, material is eroded from the block and mixed in the desired ratio with auxiliaries and solvent, for example water.

The present invention also relates to the use of the surfactant mixtures according to the invention in shaped bodies, preferably tablets, of laundry/dishwashing detergents and cleaners. The surfactant mixtures according to the invention are preferably used in detergent tablets both as heavy-duty detergent tablets with and without enzymes and in color detergent tablets. Detergent/cleaning tablets containing the surfactant mixture according to the invention, more particularly dishwasher tablets and cleaning tablets which form the cleaning solution when dissolved in water, are also preferred.

### EXAMPLES

Washing performance at 30° C. was tested in a Miele W 918 washing machine. A 30-minute delicates program was selected. The water hardness was 16°d and the machine load consisted of 3.5 kg of standard washing. Washable soils (10D, 20D, 30D, 10C, 20C, E-RO-B) and cosmetic soils (10LS, 10MU, 20MU, H-LS-PBV) were tested. Whiteness was measured photometrically against a standard (barium sulfate).

The compositions of the powder-form and liquid preparations and the washing results are set out in Tables 1 and 2. Examples 1 and 2 correspond to the invention, Examples C1 and C2 are intended for comparison. All quantities are percentages by weight.

TABLE 1
Compositions of the powder formulation and washing results

| Composition | 1 | C1 |
|---|---|---|
| Oleyl alcohol + 8EO/dodecyl | 20 | 1 |
| benzenesulfonate sodium salt = 1:3) | | |
| Coconut alcohol + 7EO | — | 5 |
| Dodecyl benzenesulfonate sodium salt | — | 15.0 |
| Palm kernel oil fatty acid sodium salt | 1 | 1 |
| Sodium silicate | 2 | 2 |
| Sodium carbonate | 5 | 5 |
| Zeolite A | 30 | 30 |
| Polycarboxylate | 3 | 3 |
| Sodium perborate | 13 | 13 |
| Silicone defoamer | 2 | 2 |
| TAED | 7 | 7 |

| | |
|---|---|
| Sodium sulfate, water | to 100 |

| | | |
|---|---|---|
| Reflectance [%-Refl.] | | |
| cosmetic soils | 76 | 77 |
| washable soils | 33 | 34 |

TABLE 2
Compositions of the liquid formulation and washing results

| Composition | 2 | C2 |
|---|---|---|
| Oleyl alcohol + 8EO/lauryl sulfate sodium salt = 5:1) | 30.0 | — |
| Coconut alcohol + 7EO | — | 25.0 |
| Lauryl sulfate sodium salt | — | 5.0 |
| Fatty acid | 16.0 | 16.0 |
| Sodium citrate | 5 | 5 |
| Water | to 100 | |
| Reflectance [%-Refl.] | | |
| cosmetic soils | 77 | 75 |
| washable soils | 36 | 34 |

The results of the foaming behavior tests on formulation 3 according to the invention and comparison formulations C3, C4 and C5 are set out in Table 3. To determine the maximum foam score, 3.5 kg standard washing was washed in a Miele W 918 washing machine at a temperature of 90° C. (full wash cycle). 75 g of the test formulations in Table 3 were directly introduced into the drum immediately before washing. The foam formed during washing was observed and measured every 10 minutes. The maximum foam height was given a score of 0 to 6 on the following scale:

0=no foam visible

1=foam fills ¼ of the bull's eye

2=foam fills ½ the bull's eye

3=foam fills ¾ of the bull's eye

4=bull's eye completely filled with foam

5=foam in dispensing compartment

6=machine overfoams

TABLE 3
Foaming behavior

| Composition | 3 | C3 | C4 | C5 |
|---|---|---|---|---|
| Sodium perborate | 20 | 20 | 20 | 20 |
| Sodium carbonate | 25.6 | 25.6 | 25.6 | 25.6 |
| Zeolite (Wessalith P) | 26.6 | 26.6 | 26.6 | 26.6 |
| TAED | 3.4 | 3.4 | 3.4 | 3.4 |
| Sodium sulfate | 3.4 | 3.4 | 3.4 | 3.4 |
| Oleyl alcohol + 8EO/dodecyl benzene- | 20 | | | |
| sulfonate sodium salt = 1:1) | | | | |
| Coconut alcohol + 7EO/dodecyl benzene- | | 20 | | |
| sulfonate sodium salt = 1:1) | | | | |
| C_{13/15} oxoalcohol + 7EO (Lutensol | | | 20 | |
| AO 7 ®)/dodecyl benzenesulfonate sodium | | | | |
| salt = 1:1) | | | | |
| C_{14/15} oxoalcohol + 7EO (Neodol 45-7 ®)/ | | | | 20 |
| dodecyl benzenesulfonate sodium salt 1:1) | | | | |
| Defoamer* | 1 | 1 | 1 | 1 |
| Max. foam score | 1 | 5 | 6 | 6 |

*Silicone-free paraffin-based defoamer (Dehydran 770 ®)

1. Surfactant mixture containing
a. fatty alcohol alkoxylates corresponding to formula (I) based on vegetable unsaturated fatty alcohols with iodine values of 20 to 130 and a conjuene content of less than 4.5%:
R¹—O(CH₂R²CHO)ₓ—H (I)
in which
R¹ is an alkenyl group containing 6 to 22 carbon atoms.
R² is hydrogen or a methyl or ethyl group and
x has a value of 1 to 50, and
b. anionic surfactants.

2. A surfactant mixture as claimed in claim 1, characterized in that it contains anionic surfactants selected from the group consisting of alkyl and/or alkenyl sulfates, alkyl ether sulfates, alkyl benzenesulfonates, soaps, monoglyceride (ether) sulfates and alkanesulfonates.

3. A surfactant mixture as claimed in claim 1, characterized in that it contains fatty alcohol alkoxylates of formula (I) and anionic surfactants in a ratio by weight of 1:90 to 90:1.

4. A surfactant mixture as claimed in claim 1, characterized in that fatty alcohol alkoxylates of formula (I) and anionic surfactants expressed as active substance are present in quantities of 0.1 to 89% by weight, based on the mixture.

5. A surfactant mixture as claimed in claim 1, characterized in that co-surfactants and/or disintegrators are optionally present.

6. A surfactant mixture as claimed in any of claims 1 to 5, characterized in that they contain co-surfactants selected from the group of nonionic surfactants consisting of alkyl and/or alkenyl oligoglycosides, hydroxy mixed ethers, alkoxylates of alkanols, end-capped alkoxylates of alkanols, fatty acid lower alkyl esters and amine oxides.

7. A surfactant mixture as claimed in any of claims 1 to 6, characterized in that it contains co-surfactants selected from the group of cationic and/or amphoteric surfactants as formed by esterquats, alkyl betaines, alkyl amidobetaines, imidazolinium betaines.

8. A surfactant mixture as claimed in any of claims 1 to 7, characterized in that it is present in granular form and is optionally compacted before, during or after granulation.

9. Laundry detergents, dishwashing detergents and cleaning compositions containing the surfactant mixture claimed in any of claims 1 to 8.

10. Laundry detergents, dishwashing detergents and cleaning compositions containing the surfactant mixture claimed in claim 9, characterized in that they are present in granular form and contain surfactants and disintegrators in a ratio by weight of 1:10 to 10:1.

11. Detergent tablets containing
a. 0.1 to 90% by weight of the surfactant mixture claimed in claims 1 to 8,
b. 0 to 50% by weight of other nonionic surfactants,
c. 0 to 10% by weight of cationic surfactants,
d. 0 to 10% by weight of amphoteric surfactants,
e. 0 to 35% by weight of bleaching agents,
f. 0 to 70% by weight of builders,
g. 0.1 to 25% by weight of disintegrators,
h. 0 to 25% by weight of defoamers,
based on the tablet.

12. Solid, powder-form detergents containing
a. 0.1 to 90% by weight of the surfactant mixture claimed in any of claims 1 to 8,
b. 0 to 50% by weight of other nonionic surfactants,
c. 0 to 35% by weight of bleaching agents,
d. 0 to 70% by weight of builders,
e. 0 to 25% by weight of defoamers,
i. 0 to 5% by weight of disintegrators,
based on the detergent.

13. Liquid, paste-form and/or gel-form detergents containing
a. 0.1 to 90% by weight of the surfactant mixture claimed in any of claims 1 to 8,
b. 10 to 99% by weight of water,
c. 0 to 50% by weight of other nonionic surfactants,
d. 0 to 10% by weight of builders,
e. 0 to 25% by weight of defoamers,
based on the detergent.

14. Detergents as claimed in any of claims 11 to 13, characterized in that they contain 0.5 to 5% by weight, based on the detergent, of preferably paraffin-based defoamer.

15. The use of the surfactant mixture claimed in any of claims 1 to 8 in liquid, paste-form and/or gel-form laundry detergents, dishwashing detergents and cleaning compositions.

16. The use of the surfactant mixture claimed in any of claims 1 to 8 in solid, powder-form laundry detergents, dishwashing detergents and cleaning compositions.

17. The use of the surfactant mixture claimed in any of claims 1 to 8 in shaped bodies, particularly tablets, of laundry detergents, dishwashing detergents and cleaning compositions.
